(19) United States
(12) Patent Application Publication
(10) Pub. No.: US 2014/0124632 A1
(43) Pub. Date: May 8, 2014

(54) Strap Supported Cup and Article Holder

(71) Applicants: Roy Quinton Bouse, Port Bolivar, TX (US); Lucas Bouse, Port Bolivar, TX (US)

(72) Inventors: Roy Quinton Bouse, Port Bolivar, TX (US); Lucas Bouse, Port Bolivar, TX (US)

(21) Appl. No.: 13/670,760

(22) Filed: Nov. 7, 2012

(51) Int. Cl. F16M 13/02

(52) U.S. Cl. 248/205.1

(57) ABSTRACT

Disclosed is a beverage and article holder having a variable strap support means. The holder comprises a cylindrical structure having a backside surface and an outer surface, the backside surface providing a plurality of apertures to accept a strap to weave therethrough. The apertures are such that the strap connector can be oriented in either a vertical or horizontal orientation to provide connection about a horizontal or vertical support means, respectively. Adjacent to the cylindrical beverage holder may be provided an outermost receptacle for further articles or cigarette waste, while an inner container may further be positioned between the beverage holder and the backside surface to provide a sealed container therebetween. The device is designed for use with leisure pool floats, but can be adapted to connect to any suitable support having a horizontal or vertical member for the strap to encircle.

### BACKGROUND OF THE INVENTION

1. Field of the Invention

The present invention relates to a modular article support for connection to a horizontal or vertical support member. More specifically, the present invention relates to a water float or vertical support member cup holder and article retainer having a strap connector and modular configuration.

While engaging in leisure activities such as pool swimming and outdoor barbeque grilling, many individuals enjoy resting on floating tubes along a pool surface. This activity allows the individual to enjoy the weather, sunbathe and relax while sitting in a support float. These tubes and floating devices are provided in numerous shapes, sizes and configurations; however not all are constructed having built-in cup or article holders that allow a user to rest a beverage, a pack of cigarettes or a cell phone safely therein while on the float and in the pool. Without such support, the user is required to manually hold the article while floating, or rest it along the side of the pool and paddle over to its location when retrieval is desired.

Devices describing cup holders are well described in the art, and generally relate to a cylindrical body or structure having a cavity to accept a cup or article therein. However, most devices describe cup holders that are built into an existing structure or a cup holder having a specific means of attaching to a support member. The present invention provides a cup and article support device having at least one cavity and a modular strap attachment means, whereby the cavity may be supported from another member by orienting the strap in either a vertical or horizontal orientation and attaching around the support member. Devices existing utilize rigid members or strap connection means that are oriented only in a horizontal direction, such that the device is only supportable using a vertical member.

2. Description of the Prior Art

Devices have been disclosed in the prior art that relate to cup and article holders. These include devices that have been patented and published in patent application publications, and generally relate to structures adapted for connection to a single support type, whereby an article support is held by either a horizontal or vertical in a hanging and snug position. The present invention provides flexibility with regard to support type and orientation, and is designed for either horizontal or vertical support member connection. The device fulfills a long felt need in the art by addressing the issue of beverage or article support when deployed in different environments, including leisure activities and rounded float tubes. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,056,696 to Lahr discloses a beverage container holder for retaining and supporting a beverage in an upright manner, where the holder comprises a body having a lower container support and an upper container retainer spaced apart from one another and connected by upright, parallel members. A belt attachment member allows the assembly to be attached to a wearer's belt. A first and second set of vertical belt slots allow connection of the assembly to a belt, permitting use of the cup support without physical handling by a user. The present invention relates to a cup holder support and container that is adapted for either vertical or horizontal strap engagement, whereby the assembly is attachable around a vertical or horizontal member and provides inherent utility for supporting a cup and other personal items.

U.S. Pat. No. 6,145,715 to Slonim discloses a belt and bicycle mountable beverage holder comprising a washable cylindrical body having an open top and closed bottom. Three bands having closure segments define a vertical and horizontal support for securing about a bicycle frame or for connect around a user's belt. The three bands provide connection to a bicycle stem, crossbar and neck to secure the cup or bottle supporting assembly in place while cycling. The Slonim device is one that comprises a cylindrical support having several interlocking straps for connect to both an upright and horizontal member. The present invention provides an article support that is adapted for connection around a horizontal member, such as a water float tube, or a vertical member such as a post. The present invention provides a support that accepts a strap in a horizontal or vertical configuration so as to provide flexibility of deployment.

Another device is U.S. Pat. No. 6,029,938 to Fava, which discloses a cup holder adapted to be attached to a person's thigh or similar rounded structure using two arcuate and elastic members extending from the base of an upstanding cylindrical shell. The shell forms a cup support having a pair of vertical slots to allow flexure outward as the arcuate members are expanded around a rounded support structure. The members form a clamp that positions the cylindrical shell in an upright position, whereby the support is below the shell and supported cup therein. While providing a unique thigh support for a cup, the Fava device is limited to connection to rounded members and positioning the cup along the upper portion thereof. The present invention provides several variations in deployment, where the article holder can be positioned adjacent to either a horizontal or vertical support member.

U.S. Published Patent Application Publication No. 2002/0148868 to Dion-Bildstein discloses a holder for a beverage container comprising a top ring and a cavity connecting to a pair of straps extending upwardly for connection about a support member. The straps encircle a support, fold onto themselves via a connection means that supports the beverage containing cavity and a beverage in a suspended configuration. The pair of straps allows the cup to be supported from a horizontal member thereabove. Similar to the foregoing devices, the Dion-Bildstein device is limited to a horizontal support, while the present invention provides a strap connector means that can encircle either a horizontal or vertical support member.

Finally, U.S. Pat. No. 5,407,110 to Marsh, Jr. discloses a beverage carrier neck strap device that is adapted to receive containers and bottles therein. The device comprises a neck strap assembly having a pair of horizontal girth strap assemblies adapted to surround a container placed within the straps. The straps are length adjustable to provide fitment and securement of containers of varying diameter, while the neck strap supports the girth straps in a spaced configuration and extends between the girth straps to provide a base support strap for a container. The Marsh, Jr. device provides a carrying strap the supports a container in a hanging configuration, similar to the Dion-Bildstein device. The present invention provides a connecting strap for a container or beverage support such that the support is secured against a horizontal or vertical member without slack therebetween.

The present invention is an article holder adapted for use with a pool float or connection to a similar support member. The device provides a strap connector that can be oriented in either a vertical or horizontal configuration to provide the user with flexibility when deploying the device. Several embodiments are contemplated, which include a cup holder and several compartments therearound for containment of other articles or article waste. It is submitted that the present invention is substantially diverges in design elements from the prior art, and consequently it is clear that there is a need in the art for an improvement to existing article holding devices. In this regard the instant invention substantially fulfills these needs.

### SUMMARY OF THE INVENTION

In view of the foregoing disadvantages inherent in the known types of beverage and article holders now present in the prior art, the present invention provides a new holder that can be utilized for providing convenience for the user when attaching a beverage and article holder to either a horizontal or vertical support member.

It is therefore an object of the present invention to provide a new and improved article holder that has all of the advantages of the prior art and none of the disadvantages.

It is another object of the present invention to provide an article holder that includes a cylindrical beverage holder having accessory compartments and a modular strap connector means.

Another object of the present invention is to provide an article holder having a strap connector means adapted to encircle a rounded support, where the strap can be oriented from the holder in either a horizontal or vertical orientation to offer improved modularity with respect to the support being utilized.

Yet another object of the present invention is to provide an article holder that provides a water resistant compartment for use in wet environments such as pools and boats.

A final object another object of the present invention is to provide an article holder that is attachable to a pool float for use supporting beverages and other articles while engaging in leisure activities.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an exemplary embodiment of the present invention in a working state, connected to a water tube float.

FIG. 2 shows a backside view of the present invention strap connection means in a vertical orientation.

FIG. 3 shows a backside view of the present invention strap connection means deployed in a horizontal orientation, wherein the strap can be orientated from the device through apertures in either horizontal or vertical direction.

FIG. 4 shows another embodiment of the present invention having a sealed article container in conjunction with a beverage holder.

### DETAILED DESCRIPTION OF THE INVENTION

Reference is made herein to the attached drawings. Like reference numerals are used throughout the drawings to depict like or similar elements of the strap supported article holder. For the purposes of presenting a brief and clear description of the present invention, the preferred embodiment will be discussed as used for supporting a beverage and other articles using a strap connector around supports of various type and orientation. The figures are intended for representative purposes only and should not be considered to be limiting in any respect.

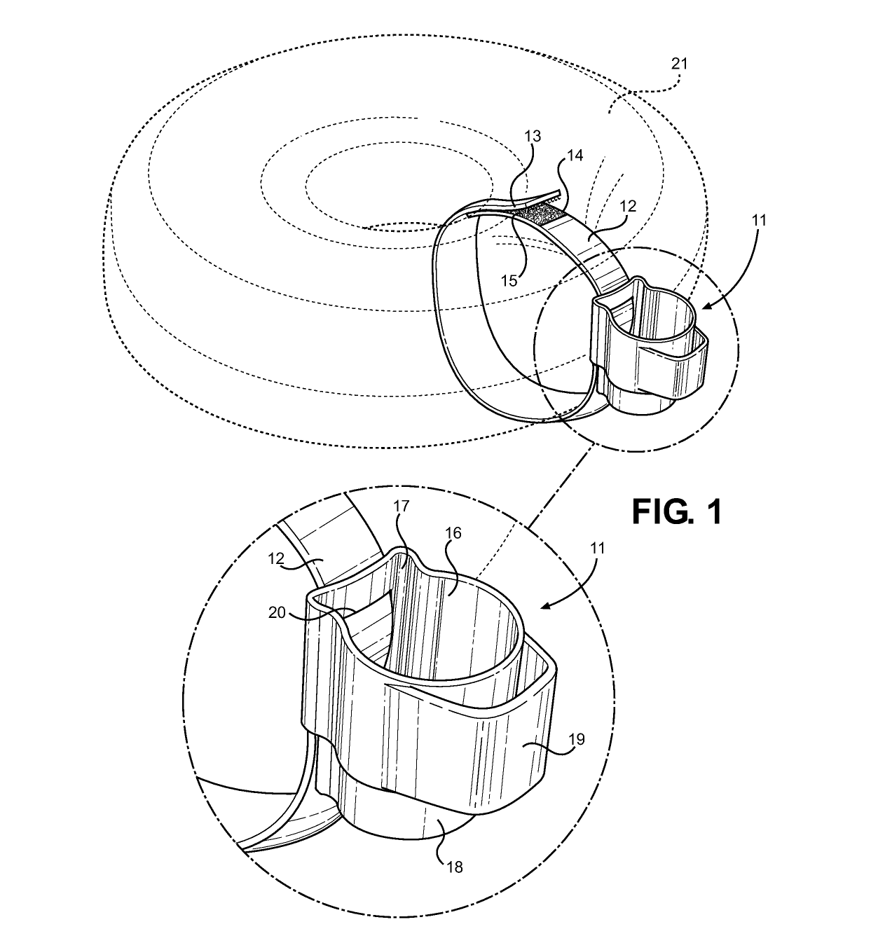

Referring now to FIG. 1, there is shown a view of an exemplary embodiment of the article holder 11 of the present invention in a working state, connected to a pool float 21 and providing an upright location within which to support beverages and other articles without requiring a user to physically hold the items. The device comprises a cylindrical housing having an open upper a 16 to accept items therein and an enclosed or partially enclosed lower portion. The sidewalls 18 of the housing may be tapered or stepped to accommodate beverage containers of differing size and shape, or the cylindrical housing may be provided in a uniform shape. The housing comprises an outer surface and a backside surface, whereby the backside surface includes a strap connection means 12 that is weaved through at least two apertures 20 in the backside surface. The surface is ideally an extended, flat surface offset 17 from the arc or perimeter of the cylindrical housing, providing a flush, offset surface upon which to place against a supporting surface.

The support surface is part of a support member 21 that may take several different sizes, shapes and configurations. The strap connector means 12 provides an encircling connector that wraps around an exposed portion of the support 21, with the strap having a first 13 and second end 15 and corresponding strap end mating means. The strap end mating means may comprise hook and loop fastening, clips or similar strap end connector, while the mating means may be adjustable or the material of the strap may be elastic to offer increased compression of the support 21 as required by the weight of the articles within the housing.

An embodiment of the article holder housing 11 is an accessory container or receptacle 19 along the exterior surface of the housing. This container 19 provides an enclosed extension having an open upper and enclosed lower portion to store accessory articles such as food or cellular phones, or alternatively may form a repository for cigarette ash. It is contemplated that this accessory container may be positioned along any portion of the housing exterior surface, including opposite of the strap 12 connector or along the sides of the housing perpendicular to the housing, as desired by the user.

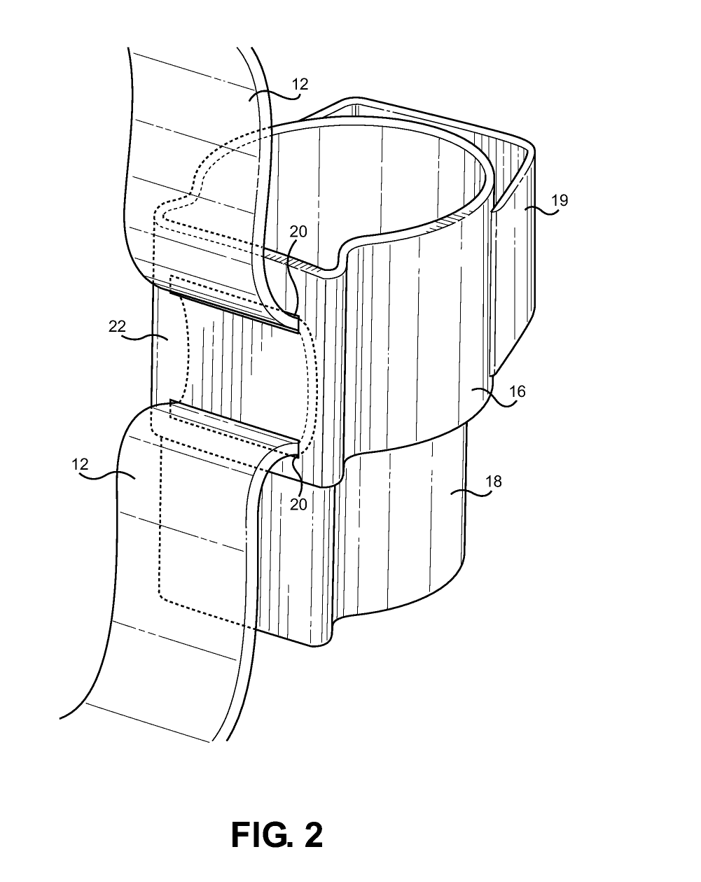

Referring now to FIG. 2, there is shown a backside perspective view of the present invention. In this view, the article holder backside surface 22 includes a first and second aperture 20 vertically spaced from one another to accept a strap 12 therethrough and in a vertical orientation. In this configuration, the strap is positioned to encircle a horizontal member, where the strap is wrapped vertically therearound and in parallel with the upstanding orientation of the article holder housing. An embodiment shown in FIG. 2 further includes the stepped configuration of the housing, where the housing includes a reduced cross section lower portion 18 and a widened upper portion 16 to accept beverages in varying configuration and size.

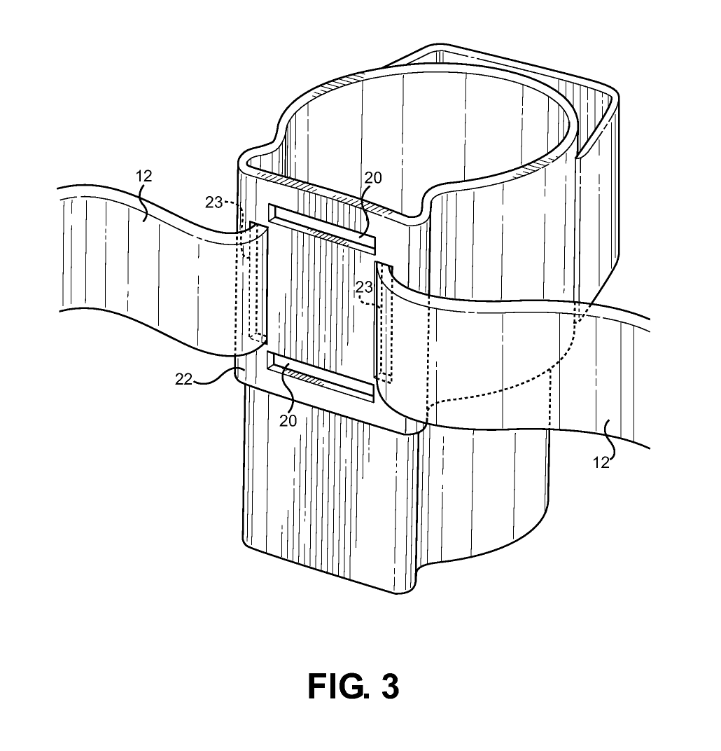

Referring now to FIG. 3, there is shown a backside perspective view of an embodiment that contemplates a backside surface 22 having first and second set of apertures. The first set includes a pair of vertically spaced apertures 20 that permit the strap connector means 12 to be fed vertically through the backside surface, while the second set includes a pair of horizontally spaced apertures 23, which allow the strap 12 to be positioned horizontally through the backside surface 22. This configuration allows the strap 12 to be orientated as required by the user to connect to either a vertical support or horizontal support, expanding the applicable supports that can be utilized while still positioning the article housing in an upright configuration.

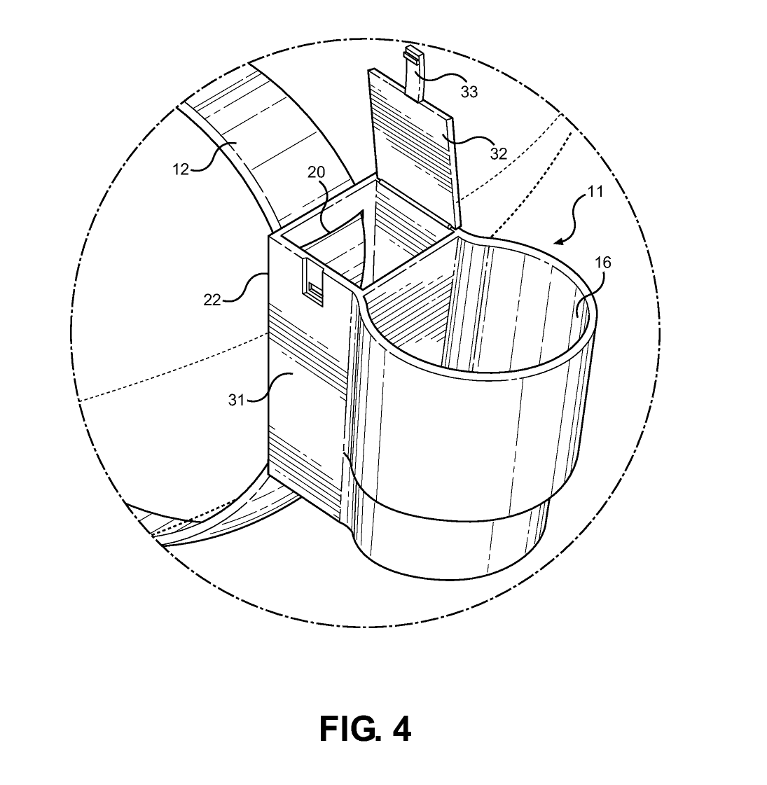

Referring now to FIG. 4, there is shown an overhead perspective view of an embodiment of the present article holder having a rear-mounted article container 31 between the device backside surface 22 and the beverage cylindrical housing 11. The container 31 may include an open upper and an enclosed lower portion for freely placing objects therein, or preferably the upper is sealable with a water tight lid 32 that is secured using a lid connector element 33. This allows the user to place sensitive or electronic devices within the container 31 interior without fear of the having them water damaged, particularly when the holder device is utilized in conjunction with a pool float. As with the previous embodiments, the strap 12 feeds through apertures 20 along the backside surface of the device. In the water resistant embodiment, the backside surface and strap apertures are offset from the backside of the container 31 such that no through-holes are present in the container that would otherwise breach the watertight integrity of the container 31.

The present invention provides a beverage and article support device that can be deployed using a vertical or horizontal strap connector means. Several embodiments are disclosed that offer modularity with respect to the device attachment and its container elements. It is contemplated that the present holder be used in conjunction with a pool float while supporting objects such as beverages, sunglasses and cigarettes while in the pool. It is further contemplated that the device may be employed in a number of other situations where article holding is desired about an exposed support member. The construction of the device may include a unitary, molded structure, or may further be of composite element construction. The lid 32 of the rear container 31 is preferably hinged from one side, while an opposing side includes a connector means that affects a waterproof seal around the periphery of the rear container opening.

In light of the existing prior art devices and the foregoing disclosure, it is submitted that the present invention provides a new and novel article support means and means of connecting to different support articles. It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An article holder, comprising:
a rounded housing having an interior volume, and open upper, a base, an exterior surface and a planar backside surface;
said backside surface having a first pair of slotted apertures;
an elongated strap for encircling an external support and having a first and second strap end, said strap capable weaving through said first pair of apertures;
said strap ends having a strap end mating means to connect said ends together into a continuous strap loop.

2. The device of claim 1, wherein said rounded housing further comprises a lower portion and an upper portion, said lower having a reduced cross section from said upper portion to accommodate articles of different size.

3. The device of claim 1, wherein said rounded housing base further comprises a surface having at least one aperture therethrough to allow condensation escape said housing interior.

4. The device of claim 1, wherein said housing backside surface is offset from said rounded housing exterior surface.

5. The device of claim 1, wherein said rounded house exterior surface further comprises an accessory receptacle having an open upper, and sidewalls extended outward from said housing exterior surface and a base.

6. The device of claim 1, wherein said first pair of slotted apertures is spaced vertically apart and in a horizontal orientation to allow said strap to weave through said first pair of apertures in a vertical orientation

7. The device of claim 1, wherein said first pair of slotted apertures is spaced horizontally apart and in a vertical orientation to allow said strap to weave through said first pair of apertures in a horizontal orientation

8. The device of claim 1, wherein:
said backside surface further comprises a second pair of slotted apertures; said first pair of slotted apertures is spaced vertically apart and in a horizontal orientation;
said second pair of slotted apertures is spaced horizontally apart and in a vertical orientation;
said first and second pair of apertures allowing said strap to weave through said first or second pair of apertures in a vertical or horizontal orientation.

9. The device of claim 1, further comprising:
an article container between said rounded housing and said backside surface;
said article container having an open upper and a base.

10. The device of claim 9, wherein said article container further comprises a lid to seal said container open upper.

11. The device of claim 9, wherein:
said article container further comprises a lid to seal said container open upper and effectuate a waterproof seal of said container interior;
said backside surface being offset from said container whereby said backside surface apertures do not impinge into said container waterproof interior.
